(19) United States
(12) Patent Application Publication
(10) Pub. No.: US 2025/0291845 A1
(43) Pub. Date: Sep. 18, 2025

(54) ARTIFICIAL INTELLIGENCE ASSISTED STREAMING VIDEO SCENE SELECTION

(71) Applicant: Rishi Kumar, Porter Ranch, CA (US)

(72) Inventor: Rishi Kumar, Porter Ranch, CA (US)

(21) Appl. No.: 18/608,841

(22) Filed: Mar. 18, 2024

(51) Int. Cl. G06F 16/738; G06F 16/74; G06F 16/783

(52) U.S. Cl. CPC G06F 16/738; G06F 16/743; G06F 16/7844

(57) ABSTRACT

Aspects of the disclosed technology provide solutions for using a Machine Learning (ML) model to interpret a user query and locate one or more scenes on a streaming video application. The apparatus, consisting of memory and a processor connected to the memory, facilitates the reception of search queries from a user through a remote device. Utilizing the ML model, the processor conducts a comprehensive search of a content database specific to the streaming application to pinpoint relevant scene(s) that correspond to the user's request. The identified scenes are then presented on a display device. This approach simplifies the process of navigating extensive video content, providing users with an efficient means to access their desired scenes directly, enhancing user engagement with the streaming video application. The disclosed technology encompasses various embodiments, suitable for application across multiple types of hardware capable of streaming media content.

### BACKGROUND

### 1. Technical Field

The present disclosure generally relates to solutions for using Artificial Intelligence (AI) to search a streaming video application and in particular, for using a Machine Learning (ML) model to interpret a user query and locate one or more scenes within streaming content available on a streaming video application.

### 2. Introduction

A streaming video application is a digital platform that allows users to watch video content over the internet in real-time, without the need to download the entire file before playback begins. This technology may allow audiences to consume entertainment and informational content and offer immediate access to a vast library of movies, TV series, documentaries, live events, and more. Streaming applications leverage advanced data compression and adaptive bitrate streaming techniques to deliver high-quality video that adjusts to the user's internet speed, ensuring a smooth viewing experience across various devices, including, but not limited to, smartphones, tablets, smart TVs, and computers.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example environment in which a user requests a scene while viewing a video on a streaming video application, according to some aspects of the disclosed technology.

FIG. 2 illustrates an example system diagram of a remote device in communication with a display device, according to some aspects of the disclosed technology.

FIG. 3 illustrates an example system diagram for locating a scene based on a user query using an artificial intelligence (AI) model, according to some aspects of the disclosed technology.

FIG. 4 illustrates an example system diagram for training a machine learning (ML) model that receives a user query and content library, according to some aspects of the disclosed technology.

FIG. 5 illustrates an example of a process for locating a scene based on a user query using an AI model, according to some aspects of the disclosed technology.

FIG. 6 illustrates another example of a process for locating a scene based on a user query using an AI model, according to some aspects of the disclosed technology.

FIG. 7 illustrates an example of a deep learning neural network, according to some aspects of the disclosed technology.

FIG. 8 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

A streaming video application is a digital platform that allows users to watch video content (also streaming content, streaming video content) displayed on an electronic screen. Streaming content examples may include, but are not limited to, movies, TV shows, documentaries, and live events. In some cases, the streaming video content may be viewed over the internet via a streaming video application in real-time without the need to download the entire file. In another example, the streaming video application may allow video content to be downloaded to a device for viewing without an internet connection.

Utilizing advanced streaming technology, streaming video applications can deliver content through a process called buffering, which can stream small chunks of the video ahead of the viewer's current playback point and may enable a smooth and uninterrupted viewing experience. This technology may adapt to the user's internet speed, dynamically adjusting video quality to maintain consistent playback. Streaming video applications may provide a user with a vast library of material across genres and languages and may cater to a wide array of preferences and interests.

The streaming video content may be viewed on an electronic screen on various devices including, but not limited to, smartphones, tablets, smart TVs, and computers. By way of example, on a smart TV, an application for a streaming service may be accessible on the smart TV (e.g., the streaming service application may be stored within memory or a computer on the smart TV and displayed on the screen of the smart TV). The user may interact (e.g., control or select options) with the streaming service (e.g., navigate a user interface displayed on the smart TV screen) via a remote device (e.g., a remote control for the smart TV).

In some cases, a user may have previously viewed video content and may encounter a problem with locating a particular scene within a TV series (e.g., a scene within an episode of a TV series with one or more episodes), film, or other streaming content. By way of example, consider a user viewing a TV series with multiple episodes where the user can recall a scene and describe it (e.g., describe the scene via the environment, characters, activity taking place, or any other choice of words to describe the scene in varying levels of detail) but the user may be unable to recall how to locate the particular scene (e.g., the user may be unable to recall the TV episode and/or timestamp within the episode containing the scene). In another example, consider the user recalling a scene within any other streaming content on the streaming video application but the user may be unable to determine where the scene is and how to locate it (e.g., which movie, TV series episode, or other streaming content contains the recalled scene). Another example may be a scene that a user wishes to find even though the user has not previously seen it.

The existing search functionalities within a streaming video application may be able to rely on titles, keywords, or episode numbers, but may be unable to allow the user to search for a specific scene. As a result, the user may need to manually comb through streaming content on the streaming video application or utilize an external search engine to find the scene they wish to revisit. The process of searching for a particular scene may be time-consuming, inefficient, and may disrupt the user viewing experience and may lead to user dissatisfaction and engagement with the content on the streaming video application.

To improve the ability of a streaming video application to locate a user queried scene within any of the available streaming content on the application, it would be helpful to have a tool that can understand a user's description of a scene and locate the scene (e.g., locate the scene within a TV episode, a film, or any other of the streaming content on the application that contains the described scene). Aspects of the disclosed technology provide solutions for locating a user described scene using artificial intelligence to interpret the user's description of the scene and providing the user the location of the scene (e.g., the streaming video application may automatically navigate to the scene or display one or more scenes that match the description that the user can select and navigate to). In some instances, the proposed solution may leverage a combination of voice recognition, natural language processing (NLP), and one or more Large Language Models (LLMs) (e.g., which may be integrated within the streaming video application) along with a remote device (e.g., a remote control for a smart TV, smartphone) with a voice input (e.g., microphone) or text input feature. By way of example, the user may describe the scene they wish to find using natural language, and the LLM may interpret the language input to locate the specific scene across the entire library of available content on the streaming video application.

In some implementations, the LLM may utilize a database of metadata associated with the library of streaming content to locate the user described scene. If the user described scene results in more than one potential scene that is found within the library of content, the streaming video application may display all the results (or zero results if no results are found) that potentially match the user's description of the scene (e.g., one or more pop-up screens, lines of text, or displayed options may appear within the streaming application for a user to select). The streaming video application may also automatically navigate to the scene that is found within the library of content (e.g., if one result is found based on the user description).

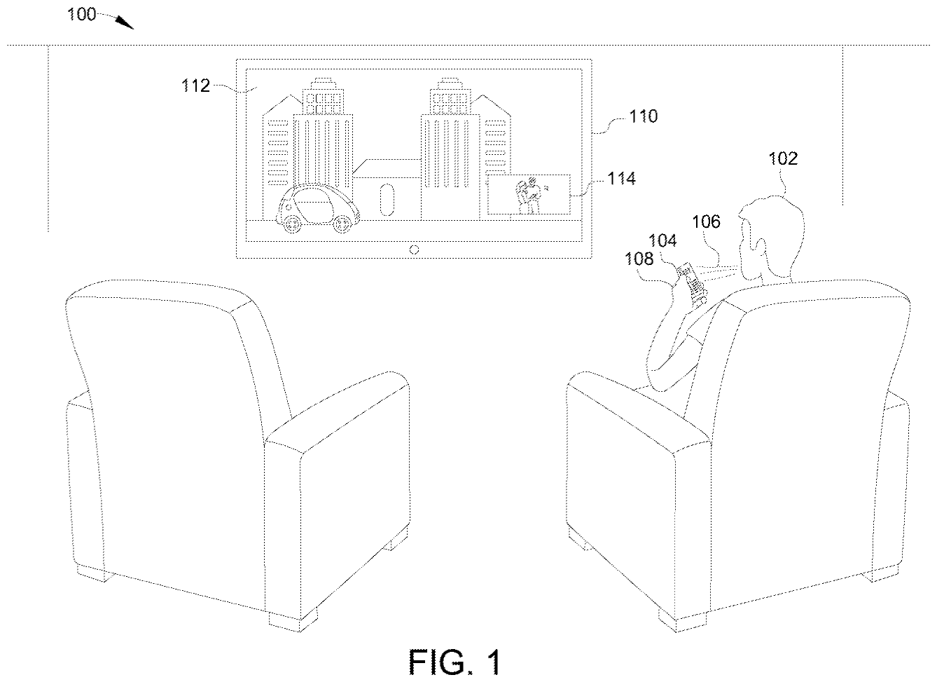

FIG. 1 illustrates an example environment 100 in which a user 102 requests a scene while viewing a video 112 on a streaming video application, according to some aspects of the disclosed technology. In the example environment 100, user 102 is viewing a video 112 via a streaming video application, displayed on display device 110. As described herein, display device 110 may refer to the apparatus operating the streaming video application, or the visual component (e.g., screen) of the apparatus operating the streaming video application. The streaming video application may be installed (e.g., on a computer or in memory) on display device 110 or accessed remotely such as via the internet and stored at a different location (e.g., a remote server or the cloud for cloud computing) than display device 110. Examples of display device 110 can be any electronic device capable of displaying video content (e.g., via a streaming video application) including, but not limited to, smart TVs, smartphones, tablet PCs, laptop computers, desktop computers, game consoles, video projectors, augmented reality (AR) devices, virtual reality (VR) devices, and holographic displays.

User 102 may interact with or control display device 110, and the streaming video application accessible via display device 110, via remote device 104. The remote device 104 may be a remote controller or any other electronic device (e.g., smartphone, tablet PC, laptop computer, desktop computer, wearable device, smartwatch, VR device, AR device, game controller, wireless keyboard, etc.) capable of controlling functions of display device 110 and/or receiving one or more instructions 106 from user 102. By way of example, user 102 may provide an instruction 106 to remote device 104 via audio (e.g., natural language) into a microphone or voice input feature capable of receiving audio data or via hand 108 to a remote device 104 with physical buttons or a touchscreen. In some examples, remote device 104 may be integrated into the display device 110. In other words, display device 110 (e.g., AR device, VR device) may be the same device that is receiving the user 102 instruction 106 and also displaying the streaming video content.

In some implementations, when user 102 communicates an instruction 106 into remote device 104 to control and interact with a streaming video application, the process of receiving, interpreting, and processing instruction 106 may be performed in remote device 104. For example, remote device 104 may capture audio associated with instruction 106, interpret instruction 106 via NLP, and transmit (e.g., via a transceiver which may transmit a wireless RF signal) the interpreted instruction 106 to display device 110. In another implementation, the audio data associated with instruction 106 may be transmitted to display device 110, and display device 110 may use NLP to interpret instruction 106 and execute the command associated with instruction 106. In another implementation, remote device 104 may transmit the audio data associated with instruction 106 to a remote service (e.g., a cloud based service) that can perform the NLP step and send the interpreted command to display device 110. This can also include a hybrid approach, where initial voice recognition and command parsing may be performed on remote device 104, and more complex NLP and contextual interpretation tasks may be offloaded to the cloud or display device 110. Those skilled in the art will appreciate additional methods of receiving, interpreting, and processing instruction 106 to interact with display device 110.

In some aspects, instruction 106 may be inputted into an LLM or any other AI tool or ML model designed to work with the streaming video application. As discussed above, instruction 106 may be audio data or any other form of data received (e.g., via a transceiver that may receive the wireless RF signal) from user 102 by remote device 104. The different variations of data formats (e.g., audio, keyboard input, AR headset input, VR headset input, hand gestures) from varying remote device 104 types corresponding to instruction 106 may be processed such that they can be inputted into a ML model. In some instances, the ML model can be trained specifically on the streaming application's content library to improve accuracy and relevance of search results, taking into account user feedback and historical interaction data to refine its understanding over time. By way of example, raw audio data or processed audio data associated with instruction 106 may be inputted into an LLM. In some implementations, the software associated with the LLM may be a feature of the streaming video application, or stored (e.g., in memory or on a computer system) directly on display device 110.

The ML model may understand instruction 106 (e.g., via parsing and contextual interpretation) and search the streaming content available on the streaming video application. For example, each piece of content on the streaming video application may be associated with metadata that can include details associated with the respective content. In addition to the described metadata, incorporating user-generated tags and annotations may enhance the search process by adding layers of social and contextual relevance. For example, metadata may include character appearances, actions, settings, dialogue, plot points, timestamps, script details, or any other types of relevant information associated with all the content available on the streaming video application. In addition, by leveraging machine learning techniques, the system may dynamically update and enrich the metadata based on user interactions and content analysis, improving search effectiveness over time. The metadata may be indexed such that the LLM may efficiently query and retrieve relevant information. Those skilled in the art will appreciate various methods for a streaming video application to store data associated with its respective available content.

In some examples, after the ML model searches the content database of the streaming video application based on instruction 106, one or more relevant scenes may be presented or displayed on display device 110. In some instances, there may be no search results, or the streaming video application may instruct user 102 to refine or redo instruction 106. The LLM may rank the one or more results 114 (e.g., relevant scenes associated with instruction 106) and display them on display device 110 for user 102. The results 114 may be displayed (e.g., by the streaming video application) on display device 110 in various methods including, but not limited to, pop-up windows, grid view, list view, carousel (e.g., scrollable row), side panel, interactive map, timeline view, gallery view, tabbed results, voice or audio feedback, or a visual summary. Those skilled in the art will appreciate the different methods of displaying search results on display device 110.

The user 102 may then select a result 114 and the streaming video application may then jump to the specific video (e.g., TV episode, movie, documentary, or any of the available content on the streaming video application) at the timestamp or scene location corresponding to the result 114 that is selected. For example, if multiple results 114 are presented, the user 102 may select the desired result for the streaming video application to jump or navigate to.

In some implementations, the streaming video application may include one or more features for personalization such that the displayed results 114 may be refined based on the user's 102 behavior (e.g., history of content viewed by user 102, browsing history, etc.), preferences, or any other information associated with user 102.

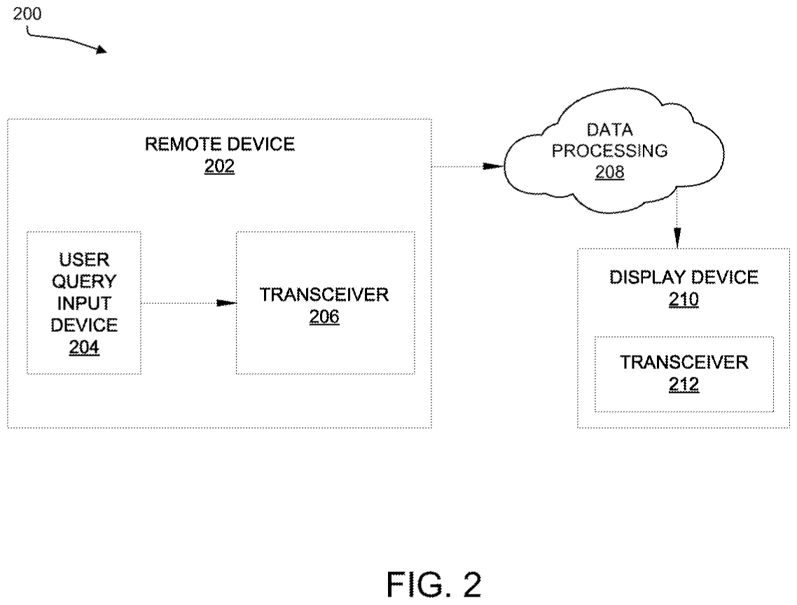

FIG. 2 illustrates an example system diagram 200 of a remote device 202 in communication with a display device 210, according to some aspects of the disclosed technology. In the example system diagram 200, a remote device 202 includes a user query input device 204 that receives a user query (e.g., a set of instructions that a user wishes to communicate). For example, user query input device 204 may be a microphone on a remote controller (or on the smart TV itself) for a smart TV capable of receiving audio or speech input from a user speaking into the microphone. In another example, user query input device 204 may be a touchscreen capable of receiving touches from a hand (e.g., hand 108 as illustrated in FIG. 1). In another example, user query input device 204 may be a set of sensors capable of tracking hand gestures or body gestures (e.g., in a VR or AR headset, where a user is communicating via body gesturing). In another example that is not illustrated in example system diagram 200 in FIG. 2, user query input device 204 may be a part of display device 210 that is outputting the video. In summary, user query input device 204 may be any device capable of receiving a communication from a user that is compatible with remote device 202. Those skilled in the art will appreciate additional examples of user query input device 204 for various remote devices 202.

In some implementations, remote device 202 may include a transceiver 206 capable of transmitting (e.g., transmitting via a wireless RF signal or via a wired direct connection) data from a user. In some cases, the user communication (e.g., raw audio data, touchscreen input data, hand gesture data) may be processed remotely at data processing 208 location (e.g., in a cloud server or at a remote location). As discussed above with respect to FIG. 1, processing may refer to processing the raw data from user query input device 204 such that the data may be fed into a ML model (e.g., LLM). The processed data may then be transmitted to a display device (display device 110 as discussed above with respect to FIG. 1) where display device 210 may receive the data via transceiver 212 and input the processed data into a machine learning (ML) model such as an LLM that can perform a search based on the processed user data.

In some cases, data processing 208 of a user instruction (e.g., user communication captured by user query input device 204 such as audio data, touchscreen data, hand gesture data, etc.) may be performed in remote device 202, a cloud server (e.g., a remote location), or display device 210. In addition, the AI model or ML model (e.g., LLM) model that can perform the search based on a user input may be in remote device 202, a cloud or remote location, or display device 210.

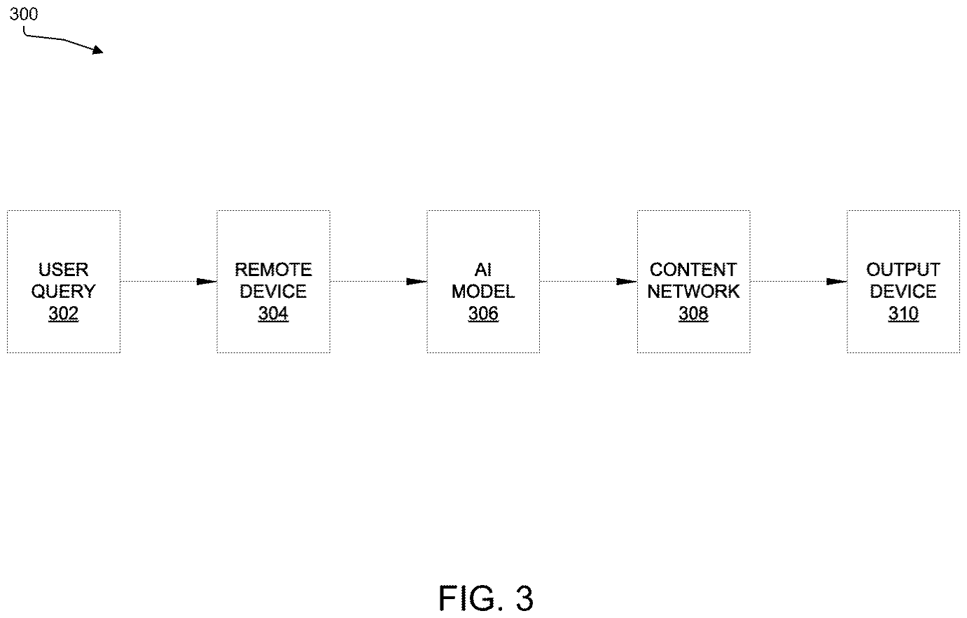

FIG. 3 illustrates an example system diagram 300 for locating a scene based on a user query using an artificial intelligence (AI) model 306, according to some aspects of the disclosed technology. The user query 302 may represent a user (e.g., a person interacting with a streaming video application) providing a search query or instructions related to a scene within a video. For example, if a user wishes to find a scene in video described as “two people sharing a cup of coffee inside a shopping mall food court”, the user may communicate these instructions to a remote device 304.

In some aspects, the user may speak these words into a remote device 304 into an audio input tool such as a microphone. The user may also provide or communicate a user query via other methods including, but not limited to, touchscreen typing, keyboard typing, gesture control (e.g., recognized by cameras and sensors), AR interfaces, VR interfaces, Brain-Computer Interfaces (BCI) and neural implants, eye tracking, facial expression recognition, and haptic feedback devices. The remote device 304 may be any electronic device capable of receiving the user query 302 via any of these methods.

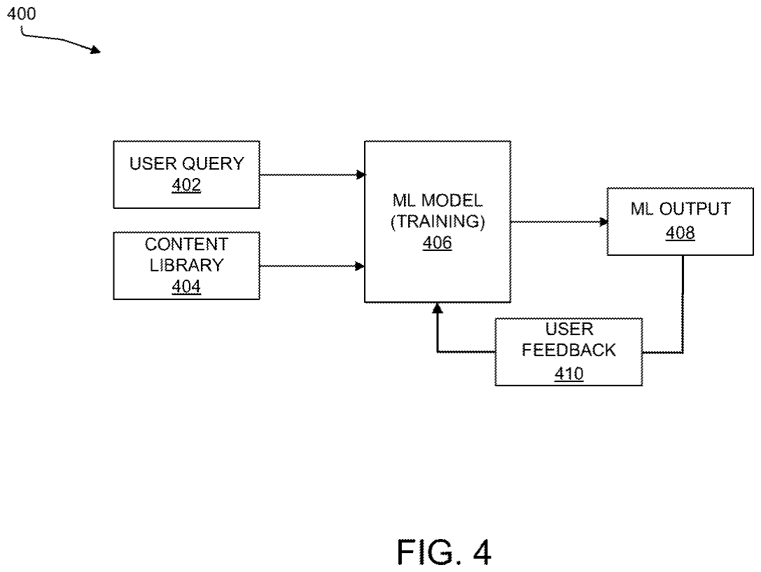

The user query 302 that is provided to remote device 304 may then be provided to an AI model 306. By way of example, AI model 306 may be the trained ML model 406 as discussed below with respect to FIG. 4. The user query 302 may be formatted or processed in any form appropriate or compatible with AI model 306. As discussed above, one type of AI model can be a Large Language Model (LLM). In addition to an LLM, various other types of AI models may be utilized to receive a user query 302 including, but not limited to, convolutional neural networks (CNNs), Recurrent Neural Networks (RNNs), Long Short-Term Memory networks (LSTM), transformer models, semantic analysis models, Graph Neural Networks (GNNs), hybrid models, zero-shot learning models, Siamese networks for similarity matching, and attention mechanism models. Those skilled in the art will appreciate additional types of AI models 306 that can receive user query 302.

In some implementations, content network 308 can represent the entire library of the streaming video application which can include the video content and associated metatags, tags, and indexing information. The AI model 306 may query content network 308 and leverage its indexed data to locate scenes that may match user query 302. By way of example, matching algorithms can be used to find the scenes (e.g., most relevant scenes) based on user query 302 which may include semantic searching, image recognition, and pattern matching. Those skilled in the art will appreciate all the different types of methods to search content network 308 based on user query 302.

After identifying relevant scenes, AI model 306 may transmit or send relevant information to an output device 310 (e.g., any electronic device capable of displaying video as described above with respect to FIG. 1, such as display device 110) that can display the search results to the user. The display of the search results via output device 310 may vary in format (e.g., pop-up windows, lists, galleries, etc.). The user may then select (e.g., via the remote device 304) one or more search results. The streaming video application may then display the selected search result via output device 310 (e.g., the streaming video application may jump to the selected scene as selected by the user from the search results).

FIG. 4 illustrates an example system diagram 400 for training a machine learning (ML) model 406 that receives a user query 402 and content library 404, according to some aspects of the disclosed technology. In the example system diagram 400, machine learning (ML) model 406 is a subset of an artificial intelligence (AI) model that may focus on learning from data (e.g., ML model 406 can adjust its parameters and improve performance automatically as it is exposed to more data).

In some implementation, user query 402 can represent a user's input (e.g., speech, touch, gesturing, BCI communication) that describes a scene they are trying to find. The content library 404 may be a database or a repository for all the video data and/or all the metadata associated with the streaming video application's video content. For example, it may include information such as scene descriptions, timestamps, character information, dialogue, settings, and more.

In some aspects, ML model 406 may be an LLM, CNN, RNN or any other model which can search for a scene within a content library 404 based on user query 402. In the training phase, ML model 406 may use content library 404 to learn how different user queries 402 correlate with specific scenes. In some instances, ML model 406 may be trained by analyzing the metadata in content library 404 to understand the context and content of the user queries 402 it can receive.

In some cases, after training, ML model 406 can process user queries 402 and output results, ML output 408. For example, the output can be a list of scenes (e.g., a list or pop-up window of relevant scenes) that match user query 402. The user may then select one of the scenes from ML output 408. In some examples, the streaming video application may prompt a user to provide additional input, or to refine user query 402 (e.g., if no search results are found).

The user feedback 410 data, including a scene that a user selects from one or more scenes from ML output 408, refining user query 402, or other user input data may be used to train ML model 406. By way of example, user feedback 410 may be used to further refine and improve ML model 406.

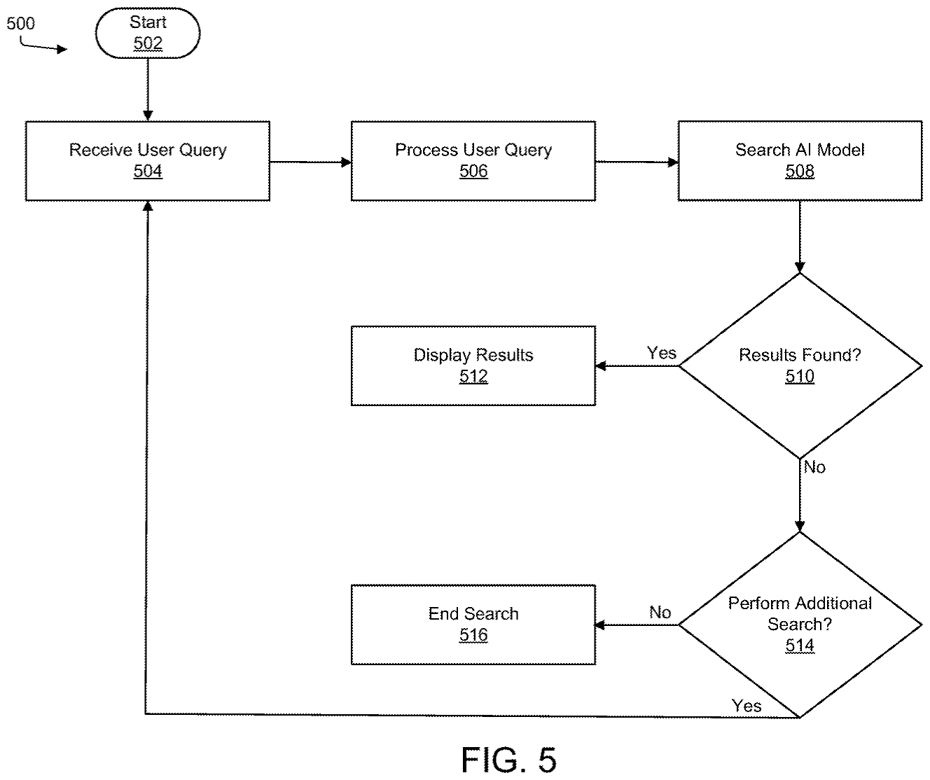

FIG. 5 illustrates an example of a process 500 for locating a scene based on a user query using an AI model, according to some aspects of the disclosed technology. In some examples, process 500 may start at step 502 where a user (e.g., user 102 as illustrated in FIG. 1) begins to use a streaming video application (e.g., streaming video application displaying video 112) on a display device (e.g., display device 110).

At step 504, a user may communicate a user query into a user query input device (e.g., user query input device 204) that can receive the user query. Next, process 500 continues to step 506 to process the use query. For example, as discussed above with respect to FIG. 2, the user query may be processed (e.g., converted into a format compatible with an AI model or ML model) in a remote device (e.g., remote device 104), at a remote location (e.g., in a cloud server or remote server), or on the display device that is displaying the video content.

At step 508, the AI model (e.g., AI model 306 or ML model 406 after training) may be any AI model that can search based on the user query received at step 504. For example, an LLM can search all the video data on a streaming video application for a scene as communicated by a user. Next, at step 510, process 500 can determine if results are found based on a user query received at step 504. If a determination is made that results are found, then process 500 can continue to step 512 to display the results on the display device (e.g., streaming video application may display the results in various formats as described above in FIG. 1). If a determination is made that no results are found (e.g., streaming video application may display a notification that no results are found), then process 500 can continue to step 514 to determine if another search should be performed. For example, the streaming video application may prompt a user to do another search or refine the previously inputted search (e.g., from step 504). If a user decides to not perform an additional search, then process 500 can continue to step 516 to end the search process (e.g., the streaming video application will end the scene search process). If a user decides to perform another search, then process 500 may return to step 504 to receive a user query.

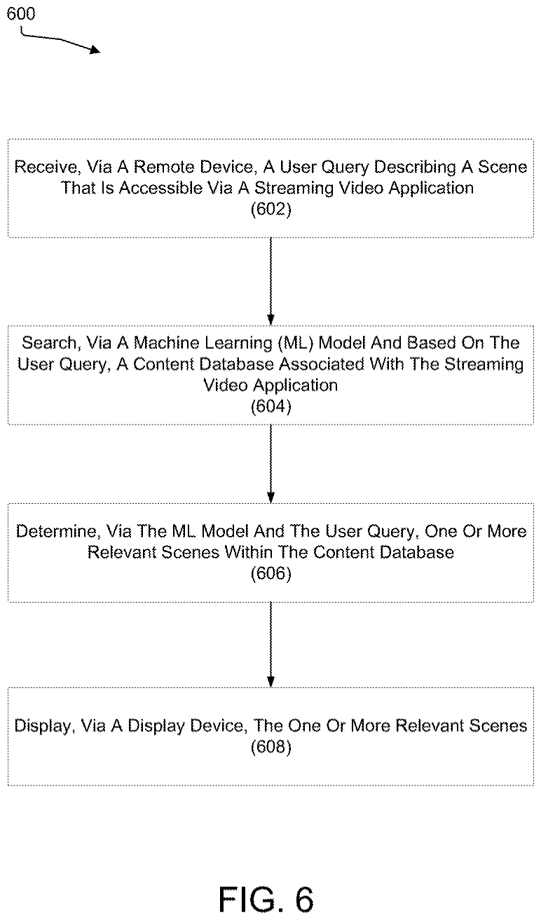

FIG. 6 illustrates another example of a process 600 for locating a scene based on a user query using an AI model, according to some aspects of the disclosed technology. At block 602, process 600 includes receiving, via a remote device, a user query describing a scene that is accessible via a streaming video application. For example, a remote device (e.g., remote device 104, 202) can receive a user query which may include a request or instruction from a user to retrieve information or perform a particular action within a system such as searching for a scene available on a streaming video application. In some implementations, the remote device may be a part of the same apparatus that is displaying the video content (e.g., VR system or AR system).

At block 604, process 600 includes searching, via a machine learning (ML) model and based on the user query, a content database associated with the streaming video application. For example, a ML model (e.g., AI model 306) after training (e.g., after training ML model 406 as illustrated in FIG. 4) can search a content database such as all the video content available, on a streaming video application (e.g., any streaming video application capable of displaying video content). In other words, the action and method by which the apparatus (e.g., display device 110, display device 210, output device 310), using its processor, can conduct a search through a content database. This content database can be a part of or associated with a streaming video application and can contain information about various scenes available in the video content hosted by the streaming video application.

At block 606, process 600 includes determining, via the ML model and the user query, one or more relevant scenes within the content database. For example, the ML model may determine one or more relevant scenes that are within all the video content of the streaming video application, that may be associated with the user's query. In other words, the ML model can analyze the user query and then may sift through the content database (e.g., within the streaming video application) to find matches. In some instances, this determination can be based on the relevance of the scenes to the query, which may involve considering various attributes and data points in the content database.

At block 608, process 600 includes displaying, via a display device, the one or more relevant scenes. As discussed above with respect to FIG. 1, the term “display device” may encompass both the apparatus operating the streaming video application (e.g., the display device 110 as illustrated in FIG. 1) and the visual output component of such an apparatus. For example, with a smart TV that includes a streaming video application, the display device may refer to an entire smart TV with an integrated streaming video application or specifically to the smart TV's screen. In another example, in the context of a smartphone running a streaming video application, “display device” could denote either the entire smartphone unit or only its screen.

In some examples, process 600 can further include steps for receiving a user selection from the one or more relevant scenes. For example, a user may select one of the results (e.g., results 114) or presented options from the one or more relevant scenes determined by the ML model. For example, with a remote controller for a smart TV, there may be a button like “Ok” or “select” to select a result. Other examples for methods to select a result may include, but are not limited to, hand gestures for AR and VR systems, mouse clicks, keyboard selections, tap on a touchscreen, voice commands, and interactive wearables. Those skilled in the art will appreciate additional examples of how to choose a selection from one or more results.

In some examples, process 600 can further includes steps for displaying, based on the user selection, a selected scene via the display device. As described above, the display device may refer to the apparatus operating the streaming video application or the visual component of the apparatus.

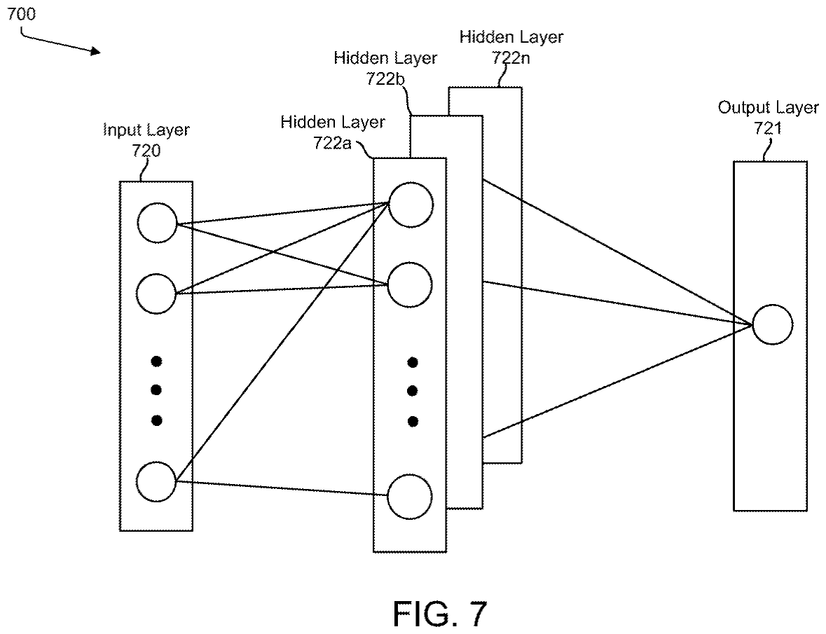

In FIG. 7, the disclosure now turns to a further discussion of models that can be used through the environments and techniques described herein. FIG. 7 is an example of a deep learning neural network 700 that can be used to implement all or a portion of the systems and techniques described herein (e.g., neural network 700 can be used to implement an ML model for searching video content within a streaming video application as discussed above). An input layer 720 can be configured to receive a user query describing a scene that is accessible via a streaming video application. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=>Σ(½(target−output)^{Λ}2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

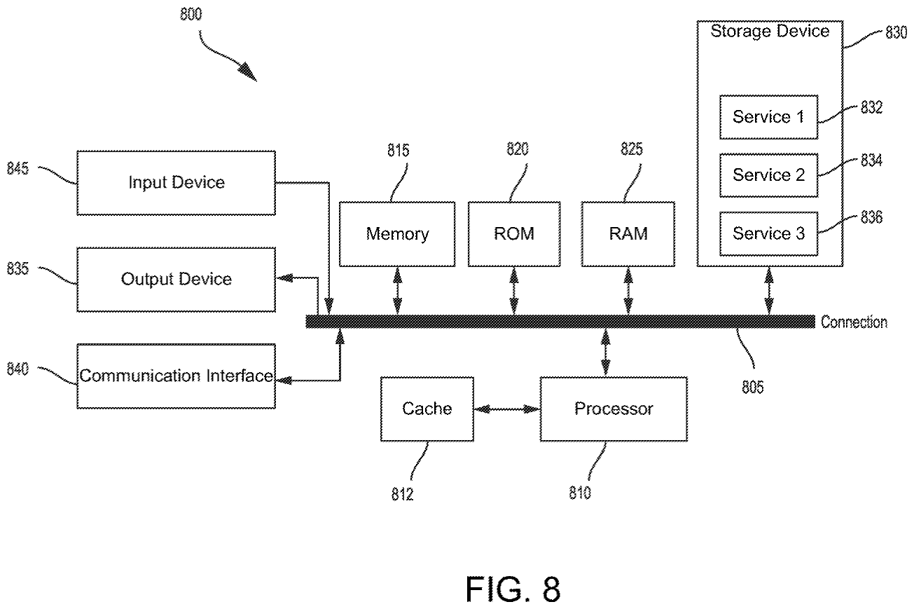

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Aspect 1. An apparatus comprising: at least one memory; and at least one processor coupled to the at least one memory, the at least one processor configured to: receive, from a remote device, a user query describing a scene that is accessible via a streaming video application; search, via a machine learning (ML) model and based on the user query, a content database associated with the streaming video application; determine, via the ML model and the user query, one or more relevant scenes within the content database; and display, via a display device, the one or more relevant scenes.

Aspect 2. The apparatus of Aspect 1, wherein the at least one processor is further configured to: receive a user selection from the one or more relevant scenes.

Aspect 3. The apparatus of Aspect 2, wherein the at least one processor is further configured to: display, based on the user selection, a selected scene via the display device.

Aspect 4. The apparatus of any of Aspects 1-3, wherein the ML model comprises at least one of a Large Language Model (LLM), convolutional neural network (CNN), recurrent neural network (RNN), long short-term memory network (LSTM), transformer model, semantic analysis model, graph neural network (GNN), hybrid model, or a combination thereof.

Aspect 5. The apparatus of any of Aspects 1-4, wherein the remote device comprises at least one of a smartphone, tablet PC, laptop computer, desktop computer, wearable device, smartwatch, virtual reality (VR) device, augmented reality (AR) device, brain-computer interface (BCI), neural implant, game controller, or a combination thereof.

Aspect 6. The apparatus of any of Aspects 1-5, wherein the apparatus comprises at least one of a smart TV, smartphone, tablet PC, laptop computer, desktop computer, game console, video projector, augmented reality (AR) device, virtual reality (VR) device, holographic display, or a combination thereof.

Aspect 7. The apparatus of any of Aspects 1-6, wherein the display device displays the one or more relevant scenes as a pop-up window, grid view, list view, carousel, side panel, interactive map, timeline view, gallery view, tabbed results, or a combination thereof.

Aspect 8. A computer-implemented method comprising: receiving, from a remote device, a user query describing a scene that is accessible via a streaming video application; searching, via a machine learning (ML) model and based on the user query, a content database associated with the streaming video application; determining, via the ML model and the user query, one or more relevant scenes within the content database; and displaying, via a display device, the one or more relevant scenes.

Aspect 9. The computer-implemented method of Aspect 8, further comprising: receiving a user selection from the one or more relevant scenes.

Aspect 10. The computer-implemented method of Aspect 9, further comprising: displaying, based on the user selection, a selected scene via the display device.

Aspect 11. The computer-implemented method of any of Aspects 8-10, wherein the ML model comprises at least one of a Large Language Model (LLM), convolutional neural network (CNN), recurrent neural network (RNN), long short-term memory network (LSTM), transformer model, semantic analysis model, graph neural network (GNN), hybrid model, or a combination thereof.

Aspect 12. The computer-implemented method of any of Aspects 8-11, wherein the remote device comprises at least one of a smartphone, tablet PC, laptop computer, desktop computer, wearable device, smartwatch, virtual reality (VR) device, augmented reality (AR) device, brain-computer interface (BCI), neural implant, game controller, or a combination thereof.

Aspect 13. The computer-implemented method of any of Aspects 8-12, wherein the computer-implemented method is executed on a device selected from the group consisting of: a smart TV, a smartphone, a tablet PC, a laptop computer, a desktop computer, a game console, a video projector, an augmented reality (AR) device, a virtual reality (VR) device, a holographic display, or any combination thereof.

Aspect 14. The computer-implemented method of any of Aspects 8-13, wherein the display device displays the one or more relevant scenes as a pop-up window, grid view, list view, carousel, side panel, interactive map, timeline view, gallery view, tabbed results, or a combination thereof.

Aspect 15. A non-transitory computer-readable storage medium comprising at least one instruction for causing a computer or processor to: receive, from a remote device, a user query describing a scene that is accessible via a streaming video application; search, via a machine learning (ML) model and based on the user query, a content database associated with the streaming video application; determine, via the ML model and the user query, one or more relevant scenes within the content database; and display, via a display device, the one or more relevant scenes.

Aspect 16. The non-transitory computer-readable storage medium of Aspect 15, wherein the at least one instruction is further configured to cause the computer or processor to: receive a user selection from the one or more relevant scenes.

Aspect 17. The non-transitory computer-readable storage medium of Aspect 16, wherein the at least one instruction is further configured to cause the computer or processor to: display, based on the user selection, a selected scene via the display device.

Aspect 18. The non-transitory computer-readable storage medium of any of Aspects 15-17, wherein the ML model comprises at least one of a Large Language Model (LLM), convolutional neural network (CNN), recurrent neural network (RNN), long short-term memory network (LSTM), transformer model, semantic analysis model, graph neural network (GNN), hybrid model, or a combination thereof.

Aspect 19. The non-transitory computer-readable storage medium of any of Aspects 15-18, wherein the remote device comprises at least one of a smartphone, tablet PC, laptop computer, desktop computer, wearable device, smartwatch, virtual reality (VR) device, augmented reality (AR) device, brain-computer interface (BCI), neural implant, game controller, or a combination thereof.

Aspect 20. The non-transitory computer-readable storage medium of any of Aspects 15-19, wherein the display device displays the one or more relevant scenes as a pop-up window, grid view, list view, carousel, side panel, interactive map, timeline view, gallery view, tabbed results, or a combination thereof.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus comprising:
at least one memory; and
at least one processor coupled to the at least one memory, the at least one processor configured to:
receive, from a remote device, a user query describing a scene that is accessible via a streaming video application;
search, via a machine learning (ML) model and based on the user query, a content database associated with the streaming video application;
determine, via the ML model and the user query, one or more relevant scenes within the content database; and
display, via a display device, the one or more relevant scenes.

2. The apparatus of claim 1, wherein the at least one processor is further configured to:
receive a user selection from the one or more relevant scenes.

3. The apparatus of claim 2, wherein the at least one processor is further configured to:
display, based on the user selection, a selected scene via the display device.

4. The apparatus of claim 1, wherein the ML model comprises at least one of a Large Language Model (LLM), convolutional neural network (CNN), recurrent neural network (RNN), long short-term memory network (LSTM), transformer model, semantic analysis model, graph neural network (GNN), hybrid model, or a combination thereof.

5. The apparatus of claim 1, wherein the remote device comprises at least one of a smartphone, tablet PC, laptop computer, desktop computer, wearable device, smartwatch, virtual reality (VR) device, augmented reality (AR) device, brain-computer interface (BCI), neural implant, game controller, or a combination thereof.

6. The apparatus of claim 1, wherein the apparatus comprises at least one of a smart TV, smartphone, tablet PC, laptop computer, desktop computer, game console, video projector, augmented reality (AR) device, virtual reality (VR) device, holographic display, or a combination thereof.

7. The apparatus of claim 1, wherein the display device displays the one or more relevant scenes as a pop-up window, grid view, list view, carousel, side panel, interactive map, timeline view, gallery view, tabbed results, or a combination thereof.

8. A computer-implemented method comprising:
receiving, from a remote device, a user query describing a scene that is accessible via a streaming video application;
searching, via a machine learning (ML) model and based on the user query, a content database associated with the streaming video application;
determining, via the ML model and the user query, one or more relevant scenes within the content database; and
displaying, via a display device, the one or more relevant scenes.

9. The computer-implemented method of claim 8, further comprising:
receiving a user selection from the one or more relevant scenes.

10. The computer-implemented method of claim 9, further comprising:
displaying, based on the user selection, a selected scene via the display device.

11. The computer-implemented method of claim 8, wherein the ML model comprises at least one of a Large Language Model (LLM), convolutional neural network (CNN), recurrent neural network (RNN), long short-term memory network (LSTM), transformer model, semantic analysis model, graph neural network (GNN), hybrid model, or a combination thereof.

12. The computer-implemented method of claim 8, wherein the remote device comprises at least one of a smartphone, tablet PC, laptop computer, desktop computer, wearable device, smartwatch, virtual reality (VR) device, augmented reality (AR) device, brain-computer interface (BCI), neural implant, game controller, or a combination thereof.

13. The computer-implemented method of claim 8, wherein the computer-implemented method is executed on a device selected from the group consisting of: a smart TV, a smartphone, a tablet PC, a laptop computer, a desktop computer, a game console, a video projector an augmented reality (AR) device, a virtual reality (VR) device, a holographic display, or any combination thereof.

14. The computer-implemented method of claim 8, wherein the display device displays the one or more relevant scenes as a pop-up window, grid view, list view, carousel, side panel, interactive map, timeline view, gallery view, tabbed results, or a combination thereof.

15. A non-transitory computer-readable storage medium comprising at least one instruction for causing a computer or processor to:
receive, from a remote device, a user query describing a scene that is accessible via a streaming video application;
search, via a machine learning (ML) model and based on the user query, a content database associated with the streaming video application;
determine, via the ML model and the user query, one or more relevant scenes within the content database; and
display, via a display device, the one or more relevant scenes.

16. The non-transitory computer-readable storage medium of claim 15, wherein the at least one instruction is further configured to cause the computer or processor to:
receive a user selection from the one or more relevant scenes.

17. The non-transitory computer-readable storage medium of claim 16, wherein the at least one instruction is further configured to cause the computer or processor to:
display, based on the user selection, a selected scene via the display device.

18. The non-transitory computer-readable storage medium of claim 15, wherein the ML model comprises at least one of a Large Language Model (LLM), convolutional neural network (CNN), recurrent neural network (RNN), long short-term memory network (LSTM), transformer model, semantic analysis model, graph neural network (GNN), hybrid model, or a combination thereof.

19. The non-transitory computer-readable storage medium of claim 15, wherein the remote device comprises at least one of a smartphone, tablet PC, laptop computer, desktop computer, wearable device, smartwatch, virtual reality (VR) device, augmented reality (AR) device, brain-computer interface (BCI), neural implant, game controller, or a combination thereof.

20. The non-transitory computer-readable storage medium of claim 15, wherein the display device displays the one or more relevant scenes as a pop-up window, grid view, list view, carousel, side panel, interactive map, timeline view, gallery view, tabbed results, or a combination thereof.
